(19) United States
(12) Patent Application Publication
(10) Pub. No.: US 2024/0320675 A1
(43) Pub. Date: Sep. 26, 2024

(54) AI BASED AUTOMATIC FRAUD DETECTION POLICY DEVELOPMENT

(71) Applicant: International Business Machines Corporation, Armonk, NY (US)

(72) Inventors: Andrey Finkelshtein, Beer Sheva (IL); Nofar Ben Ari, Rehovot (IL); Noga Agmon, Givat Shmuel (IL); Rotem Russo, Ramat Gan (IL); Neta Levkovich, Givatayim (IL)

(21) Appl. No.: 18/123,549

(22) Filed: Mar. 20, 2023

(51) Int. Cl. G06Q 20/40

(52) U.S. Cl. CPC G06Q 20/4016

(57) ABSTRACT

A method of AI based automatic fraud detection policy development is provided. The method includes obtaining client data associated with a plurality of digital accounts. The obtained client data for each of the plurality of digital accounts includes at least one of legitimate activity and fraudulent activity. Features are extracted from the obtained client data. Fraudulent activity is classified in the obtained data. Policy rules associated with the classified fraudulent activity are extracted based on the extracted features. A policy model is developed based on the extracted policy rules.

### BACKGROUND

Exemplary embodiments of the present inventive concept relate to fraud detection policy, and more particularly, to an artificial intelligence (AI) based automatic fraud detection policy development.

Online fraud is perpetuated by various means, such as account-take-over, remote overlay attacks, phishing, and social engineering. It is estimated that global cybercrime (e.g., fraudulent transactions, identity fraud, etc.) will cost consumers and companies $10.5 trillion annually by 2025. Worse still, every $1 of fraud now costs U.S. retail and ecommerce merchants $3.75, which is 19.8% higher than in 2019 (which was at $3.13) and rising. In addition to the enormous monetary cost to consumers and companies, digital fraud can also cause reputational harm and ongoing aggravation through the need for remediation and constant vigilance.

Institutions (e.g., government entities, lenders, banks, etc.) rely on fraud detection policies to detect fraudulent activity. Each fraud detection policy is generated and continually evaluated by fraud analysts (or data scientists) by exhaustive analysis of voluminous data and meticulous policy rule creation. A fraud detection policy is in a state of constant evolution due to ongoing innovation by cyber criminals. However, fraud detection policy developed by fraud analysts is costly, generalized, necessarily involves update delays, and often neglects detection and modification based on isolated instances of missed fraud. Moreover, the underlying rules of fraud detection policy models are often difficult to derive and therefore challenging to understand and modify.

### SUMMARY

Exemplary embodiments of the present inventive concept relate to a method, a computer program product, and a system for AI based automatic fraud detection policy development.

According to an exemplary embodiment of the present inventive concept, a method of AI based automatic fraud detection policy development is provided. The method includes obtaining client data associated with a plurality of digital accounts. The obtained client data for each of the plurality of digital accounts includes at least one of legitimate activity and fraudulent activity. Features are extracted from the obtained client data. Fraudulent activity is classified in the obtained data. Policy rules associated with the classified fraudulent activity are extracted based on the extracted features. A policy model is developed based on the extracted policy rules.

According to an exemplary embodiment of the present inventive concept, a computer program product is provided capable of performing a method. The computer program product includes one or more computer-readable storage media and program instructions stored on the one or more non-transitory computer-readable storage media capable of performing a method. The method includes obtaining client data associated with a plurality of digital accounts. The obtained client data for each of the plurality of digital accounts includes at least one of legitimate activity and fraudulent activity. Features are extracted from the obtained client data. Fraudulent activity is classified in the obtained data. Policy rules associated with the classified fraudulent activity are extracted based on the extracted features. A policy model is developed based on the extracted policy rules.

According to an exemplary embodiment of the present inventive concept, a computer system is provided capable of performing a method. The computer system includes one or more computer processors, one or more computer-readable storage media, and program instructions stored on the one or more of the computer-readable storage media for execution by at least one of the one or more processors capable of performing a method. The method includes obtaining client data associated with a plurality of digital accounts. The obtained client data for each of the plurality of digital accounts includes at least one of legitimate activity and fraudulent activity. Features are extracted from the obtained client data. Fraudulent activity is classified in the obtained data. Policy rules associated with the classified fraudulent activity are extracted based on the extracted features. A policy model is developed based on the extracted policy rules.

According to exemplary embodiments of the present inventive concept, the method, computer program product, or computer system extract policy rules that underlie policy models (e.g., fraud detection policy models) from extracted features. This facilitates automated creation and modification of policy models without necessitating independent fraud analysts (or data scientists) deriving policy rules. Moreover, extracting policy rules that comprise a policy model also permits a better understanding of the specific criteria of constituent policy rules.

According to exemplary embodiments of the present inventive concept, the method, computer program product, or computer system classified fraudulent activity can include missed fraud based on user feedback, and the extracted policy rules can include policy rules associated with the missed fraud.

This permits extraction of policy rules associated with missed fraudulent activity in the context of developing a fraud detection policy model.

According to exemplary embodiments of the present inventive concept, the method, computer program product, or computer system developed policy model can be a pre-trained fraud detection model based on a fraud detection policy, and the developing the policy model can include updating at least one of model features and model feature thresholds based on the extracted policy rules.

This permits existent fraud detection policy models to be updated based on missed fraud according to delineated policy rules and associated criteria therefor.

### BRIEF DESCRIPTION OF THE DRAWINGS

The following detailed description, given by way of example and not intended to limit the exemplary embodiments solely thereto, will best be appreciated in conjunction with the accompanying drawings, in which:

FIG. 1 illustrates a schematic diagram of computing environment 100 including an AI based automatic fraud detection policy development program 150, in accordance with an exemplary embodiment of the present inventive concept.

FIG. 2 illustrates a block diagram of components included in the AI based automatic fraud detection policy development program 150, in accordance with an exemplary embodiment of the present inventive concept.

FIG. 3 illustrates a flowchart of AI based automatic fraud detection policy development 300, in accordance with an exemplary embodiment of the present inventive concept.

It is to be understood that the included drawings are not necessarily drawn to scale/proportion. The included drawings are merely schematic examples to assist in understanding of the present inventive concept and are not intended to portray fixed parameters. In the drawings, like numbering may represent like elements.

### DETAILED DESCRIPTION

Exemplary embodiments of the present inventive concept are disclosed hereafter. However, it shall be understood that the scope of the present inventive concept is dictated by the claims. The disclosed exemplary embodiments are merely illustrative of the claimed system, method, and computer program product. The present inventive concept may be embodied in many different forms and should not be construed as limited to only the exemplary embodiments set forth herein. Rather, these included exemplary embodiments are provided for completeness of disclosure and to facilitate an understanding to those skilled in the art. In the detailed description, discussion of well-known features and techniques may be omitted to avoid unnecessarily obscuring the presented exemplary embodiments.

References in the specification to “one embodiment,” “an embodiment,” “an exemplary embodiment.” etc., indicate that the embodiment described may include a particular feature, structure, or characteristic, but not every embodiment may necessarily include that feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether explicitly described.

In the interest of not obscuring the presentation of the exemplary embodiments of the present inventive concept, in the following detailed description, some processing steps or operations that are known in the art may have been combined for presentation and for illustration purposes, and in some instances, may have not been described in detail. Additionally, some processing steps or operations that are known in the art may not be described at all. The following detailed description is focused on the distinctive features or elements of the present inventive concept according to various exemplary embodiments.

As aforementioned, continual maintenance of fraud detection policies by fraud analysts has inherent limitations. Narrowly tailoring a fraud detection policy model and associated policy rules is tedious, costly, and inefficient. Often the policy rules that underlie a fraud detection policy model are complex and poorly understood, compromising effective evaluation and pursuant modification. The present inventive concept provides for a method, system, and computer program product for AI based automatic fraud detection policy development.

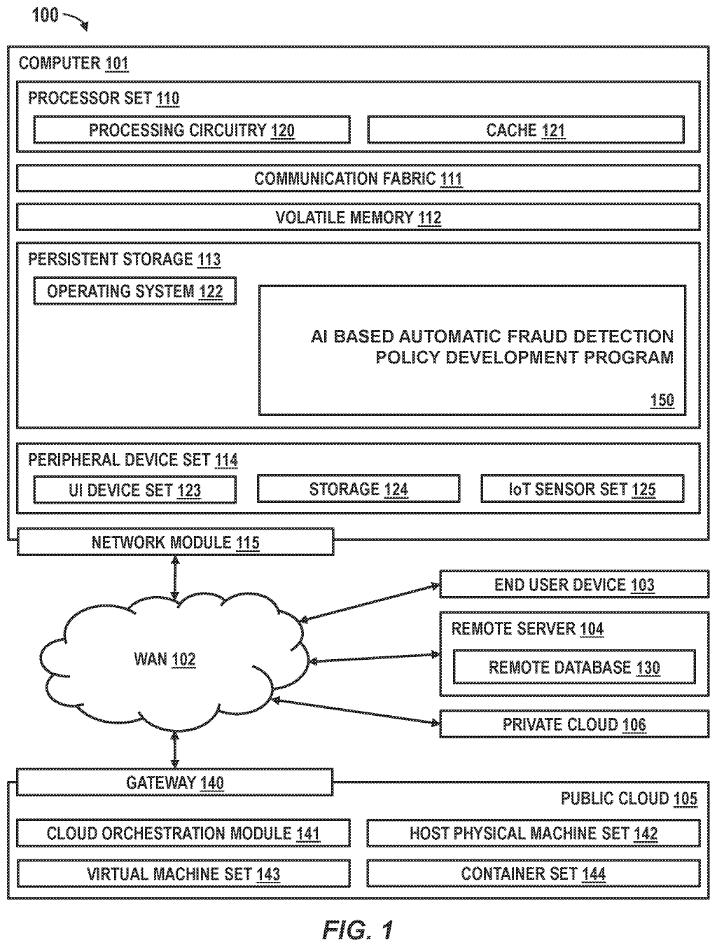

FIG. 1 illustrates a schematic diagram of computing environment 100 including an AI based automatic fraud detection policy development program 150, in accordance with an exemplary embodiment of the present inventive concept.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as an AI based automatic fraud detection policy development 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

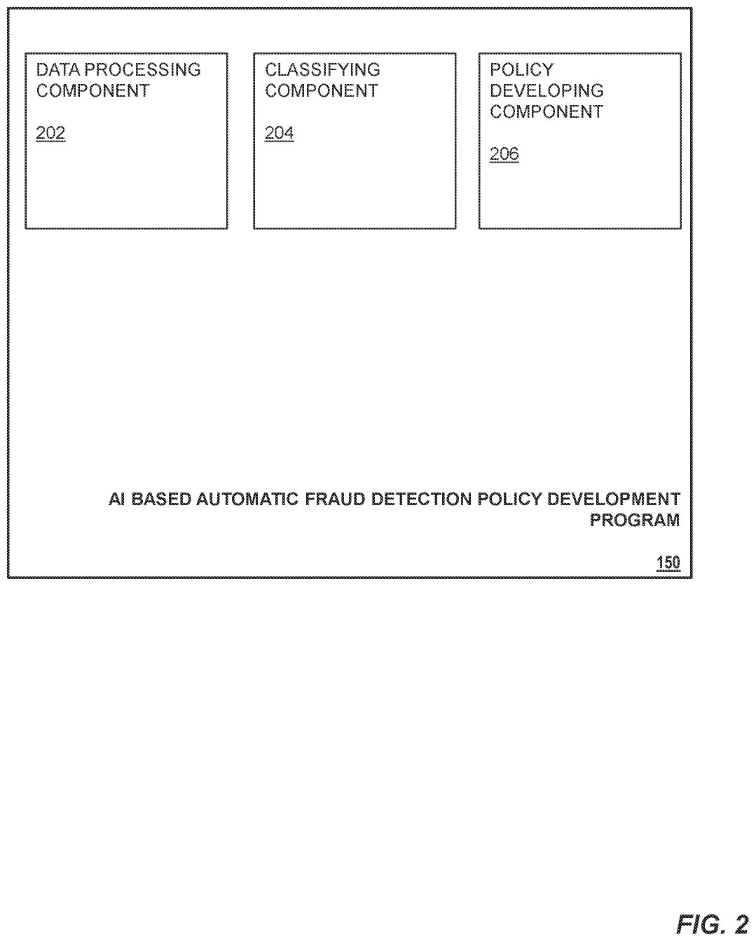

FIG. 2 illustrates a block diagram of components included in an AI based automatic fraud detection policy development program 150, in accordance with an exemplary embodiment of the present inventive concept.

The data processing component 202 can obtain client data. The obtained client data can include transaction data from at least one client (e.g., institution (e.g., bank, insurer, lender, government entity, etc.)) for least one account proprietor (e.g., client customer) by authorized access to relevant sources (e.g., websites, repositories, terminals, web-based applications, documentation of live encounters, etc.). The data processing component 202 can extract features from the obtained client data using an initial fraud detection policy model (e.g., a client policy model, a new fraud detection policy model, etc.). The extracted features can include actual and/or attempted transaction types (e.g., wire transfers, purchases (e.g., debit and/or credit), account withdrawals, loans, benefits (e.g., social security)), account access geographic data (e.g., IP addresses, region, country, state, city, etc.), device data (e.g., operating systems, devices, device types, etc.), proprietor account data (e.g., historical fraudulent activity and/or legitimate activity, login credentials, addresses, IP addresses, devices, indicated travel, password changes, authorized users, login attempt history, security question answers, etc.), interactive input data (e.g., mouse movements, audio detection, camera detected user movement, trackpad movements, etc.), and/or corresponding frequencies/thresholds therefor. The obtained client data can include at least one of fraudulent activity (e.g., known fraud, missed fraud (e.g., fraud detection policy model false negative, account proprietor reported fraud, etc.), fraudulent account access, and/or potential fraud) and legitimate activity (e.g., fraud detection policy model false positive, authorized account proprietor transaction, authorized account proprietor access, etc.).

The classifying component 204 can classify fraudulent activity and/or legitimate activity class (e.g., false positive, missed fraud, known fraud, potential fraud, etc.) based on client and/or account proprietor feedback and/or based on the extracted features. The classifying component 204 can further generate a fraud classifier model (omitted from the client's initial policy detection model) to classify missed fraud according to a missed fraud type (e.g., account take over, remote overlay attacks and social engineering) by the client and/or account proprietor feedback and/or based on the corresponding extracted features (e.g., prior account fraudulent activity, new device, new country, new internet service provider (ISP), risky country, risky internet ISP, use of remote access software, duration of interactive input data, etc.). For example, missed fraud can be based on feedback and/or classification indicating fraudulent activity that was not detected by the client's initial fraud detection policy model (e.g., intelligence report or manual investigation). The classifying component 204 can map fraudulent activity class, and/or missed fraud types to the corresponding extracted features. In an embodiment, the classifying component 204 can develop a new fraud detection policy model based on the extracted features mapped to fraudulent activity class, legitimate activity class, and/or missed fraud types. The policy developing component 206 can develop the fraud detection policy model at various times (e.g., client input, scheduled intervals, random intervals, etc.) and/or upon a triggering event (e.g., cyberattack, client and/or account proprietor reported fraudulent activity, etc.).

The policy developing component 206 can develop a rule-based fraud detection policy framework, implement the new policy fraud detection policy model, and/or tune existent fraud detection policy rules/models. The policy developing component 206 can develop the rule-based fraud detection policy framework by extracting rules from the mapped extracted features using machine learning processes (e.g., ripper algorithm, decision trees, etc.). The policy developing component 206 can present the developed rule-based fraud detection policy framework to the client. In an embodiment, the policy developing component 206 can also extract rules from an existent fraud detection policy (e.g., the fraud classifier, the client's initial fraud detection policy model, the new fraud detection policy model, etc.). The rule-based fraud detection policy framework can include rule explanations/annotations (e.g., plain English), decision logic, feature criteria, thresholds, and/or frequencies, and/or comparisons to rules of an existent fraud detection policy model. Updates to an initial fraud detection policy model can include incorporating the missed fraud classifier and/or tuning an existent fraud detection policy model based on machine learning analysis of fraudulent activity and/or legitimate activity detection accuracy (e.g., class, false positive, false negative, etc.), sensitivity (e.g., feature weights, feature thresholds, etc.), and/or the mapped extracted features (e.g., inclusion/exclusion, frequencies, thresholds, etc.). The policy developing component 206 can present suggested fraud detection policy rules, models, and/or rule/model modifications to the client for approval prior to implementation. In addition, a user can alter extracted policy rules which will modify corresponding extracted features, thresholds, and/or ranges, as well as a corresponding policy model.

Thus, policy rules underlying policy models can be extracted to automate, demystify, and/or generate or modify existent policy models.

For example:

Account proprietor data and associated reports from a bank are obtained which indicates sessions that are legitimate, reported fraudulent and known fraudulent (“confirmed fraud”), and reported legitimate but were fraudulent (“missed fraud”).
1. The missed frauds are analysed to understand why the client's fraud detection policy model did not detect them. The fraud type for at least some missed frauds is identified. The fraud type includes identifying the M.O. (method of operation) of the fraud, which includes phishing, malware, social engineering etc.
2. The fraud detection policy rules and/or models that were deficient in detecting the missed frauds are identified. Each M.O can be caught by different logic, so the rules and models are divided by that same logic.
3. The fraud detection policy rules and/or models need to be updated in order to catch the previously missed fraud types in the future.

### AI Rules Creation—Example Flow:

1. Assume we have policy rules containing 2 rules for a specific customer:
   a. Risky ISP rule containing following components and values with ‘and’ operator:
      i. Is_expected_channel (if the user used web or mobile application): ‘mobile’.
      ii. Has Min history (number of minimum previous sessions of the user): 9.
      iii. Must be new attributes (the session has new device attributes): ‘isp’, ‘machine_id’.
      iv. Isp Insight Values: fraud_db_counter_puid>4 and isp_ratio>0.00172. Insight values are features which are calculated in batch every day and are available for the policy in real time.
         For example, isp insight are features which are calculated for each isp value for a specific customer. fraud_db_counter_puid refers to how many fraud sessions were done from a specific isp isp_ratio is the ratio between number of fraud sessions to overall sessions for this isp.
   b. Velocity rule containing following components and values with ‘and’ operator:
      i. Is_expected_channel: ‘mobile’.
      ii. Has Min history: 5.
      iii. Must be new attributes: ‘region’.
      iv. Has velocity: time_diff (the time between current session and previous session): 28,
         Distance (the distance in kilometers between current session and last session): 255,
         allowed_velocity_accesses (the number of velocity sessions in user history to b allowed): 2.
2. Customer feedback: the customer labeled the sessions in the last week, for example missed fraud, confirmed fraud, and confirmed legit. Then the system is triggered to update the policy.
3. Extract Data:
   a. From our fraud database we extract fraud sessions with isp and velocity classifications and missed fraud sessions with no classifications for the last 3 months.
   b. From our legit database we extract random X sessions.
   c. From our insight database we extract isp insight.
4. Missed fraud classification:
   a. Classify the missed fraud that were labeled by the customer to relevant fraud type
      An example of the flow appears in FIG. 1.
   b. The classification of the frauds determines which frauds will be used for rules generation for each of the fraud types.
5. Preprocessing:
   a. Running our feature extractor to create features based on device and mobile data. The feature extractor gets as in input the sessions data and the insight data. We create features as history_len which is the number of sessions in user history and is_attribute_X_new refers to if attribute x is new in user history.
   b. For velocity fraud for example we use an additional preprocessing step before we can extract the final rules. The process is explained in FIG. 2.
6. Running Policy rules creator component:
   a. The system requires several inputs and configurations:
      i. Fraud sessions features file.
      ii. Legit sessions features file.
      iii. Configurations for example:
         1. MO's: isp, velocity.
         2. Minimum TPR (True positive Rate): 0.3.
         3. Maximum FPT (False positive Rate): 0.005.
   b. Then we extract large number of rules for each MO by using different machine learning and rules learning algorithms such as decision trees and RIPPER algorithm. The system has the ability to merge and combine rules generated by the different algorithms to a single rule by applying logic conditions (or, and, . . . ).
   c. The system selects top X (e.g., X=50) rules for each MO according to the configuration in clause a.
   d. We translate the rules to policy rules components for example:
      i. History_len>5=>has min history: 5.
      ii. Is_attribute_X_new=>must new attributes: X.
   e. Since sometimes rules cover the same frauds and have the same false positives. The method chooses the best rules subset for all the policy using for example the ROCCER algorithm or brute force search when possible. The algorithm chooses the best rules subset which covers as many frauds with minimal false positive rate so there at least one rule for each fraud type (preserves explain-ability).
7. The chosen rules for the policy:
   a. Risky ISP rule containing following components and values with ‘and’ operator:
      i. Is_expected_channel: ‘mobile’.
      ii. Has Min history: 5.
      iii. Must be new attributes: ‘isp’, ‘machine_id’, ‘lean_digest’, ‘os’.
      iv. Isp Insight Values: fraud_db_counter_puid>3.5 and isp_ratio>0.003.
   b. Velocity rule containing following components and values with ‘and’ operator:
      i. Is_expected_channel: ‘mobile’.
      ii. Has Min history: 5.
      iii. Some should be new>2.5.
      iv. Has velocity: time_diff: 36, distance: 517, allowed_velocity_accesses: 10.
8. Deploy new rules in our policy system.

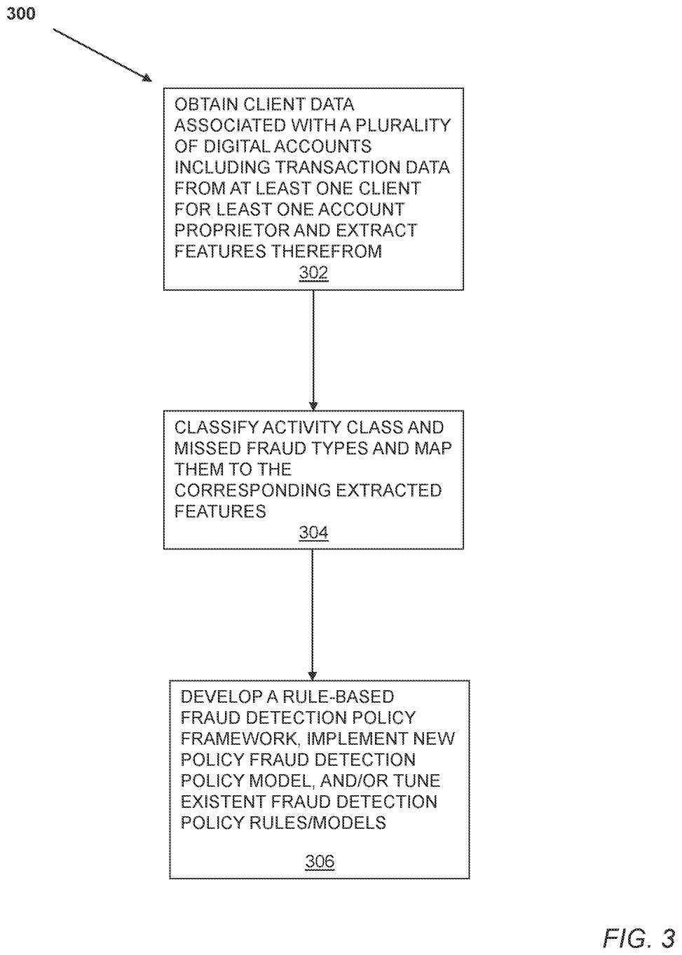

FIG. 3 illustrates a flowchart of AI based automatic fraud detection policy development 300, in accordance with an exemplary embodiment of the present inventive concept.

At step 302, the data processing component 202 can obtain client data associated with a plurality of digital accounts including transaction data from at least one client for least one account proprietor and extract features therefrom.

At step 304, the classifying component 204 can classify activity class and missed fraud types and map them to the corresponding extracted features.

At step 306, the policy developing component 206 can develop a rule-based fraud detection policy framework, implement the new policy fraud detection policy model, and/or tune existent fraud detection policy rules/models.

Based on the foregoing, a computer system, method, and computer program product have been disclosed. However, numerous modifications, additions, and substitutions can be made without deviating from the scope of the exemplary embodiments of the present inventive concept. Therefore, the exemplary embodiments of the present inventive concept have been disclosed by way of example and not by limitation.

What is claimed is:

1. A method of AI based automatic fraud detection policy development, the method comprising:
obtaining client data associated with a plurality of digital accounts, wherein the obtained client data for each of the plurality of digital accounts includes at least one of legitimate activity and fraudulent activity;
extracting features from the obtained client data;
classifying fraudulent activity in the obtained data;
extracting policy rules associated with the classified fraudulent activity based on the extracted features; and
developing a policy model based on the extracted policy rules.

2. The method of claim 1, wherein the classified fraudulent activity includes missed fraud based on user feedback, and
wherein the extracted policy rules include policy rules associated with the missed fraud.

3. The method of claim 1, wherein the developed policy model is a pre-trained fraud detection model based on a fraud detection policy, and wherein the developing the policy model includes updating at least one of model features and model feature thresholds based on the extracted policy rules.

4. The method of claim 1, wherein the classified fraudulent activity types include known fraud, potential fraud, and missed fraud.

5. The method of claim 2, wherein the extracted features corresponding to the missed fraud include at least one of remote access software, risky internet service provider (ISP), and risky country.

6. The method of claim 1, further comprising:
mapping corresponding extracted features to legitimate activity, potential fraud, known fraud, and missed fraud.

7. The method of claim 6, wherein the extracting of the policy rules is based on the mapped corresponding extracted features and a ripper algorithm or decision tree.

8. A computer program product for AI based automatic fraud detection policy development, the computer program product comprising:
one or more computer-readable storage media and program instructions stored on the one or more non-transitory computer-readable storage media capable of performing a method, the method comprising:
obtaining client data associated with a plurality of digital accounts, wherein the obtained client data for each of the plurality of digital accounts includes at least one of legitimate activity and fraudulent activity;
extracting features from the obtained client data;
classifying fraudulent activity in the obtained data;
extracting policy rules associated with the classified fraudulent activity based on the extracted features; and
developing a policy model based on the extracted policy rules.

9. The computer program product of claim 8, wherein the classified fraudulent activity includes missed fraud based on user feedback, and
wherein the extracted policy rules include policy rules associated with the missed fraud.

10. The computer program product of claim 8, wherein the developed policy model is a pre-trained fraud detection model based on a fraud detection policy, and wherein the developing the policy model includes updating at least one of model features and model feature thresholds based on the extracted policy rules.

11. The computer program product of claim 8, wherein the classified fraudulent activity types include known fraud, potential fraud, and missed fraud.

12. The computer program product of claim 9, wherein the extracted features corresponding to the missed fraud include at least one of remote access software, risky internet service provider (ISP), and risky country.

13. The computer program product of claim 8, further comprising:
mapping corresponding extracted features to legitimate activity, potential fraud, known fraud, and missed fraud.

14. The computer program product of claim 13, wherein the extracting of the policy rules is based on the mapped corresponding extracted features and a ripper algorithm or decision tree.

15. A computer system for AI based automatic fraud detection policy development, the computer system comprising:
one or more computer processors, one or more computer-readable storage media, and program instructions stored on the one or more of the computer-readable storage media for execution by at least one of the one or more processors capable of performing a method, the method comprising:
obtaining client data associated with a plurality of digital accounts, wherein the obtained client data for each of the plurality of digital accounts includes at least one of legitimate activity and fraudulent activity;
extracting features from the obtained client data;
classifying fraudulent activity in the obtained data;
extracting policy rules associated with the classified fraudulent activity based on the extracted features; and
developing a policy model based on the extracted policy rules.

16. The computer system of claim 15, wherein the classified fraudulent activity includes missed fraud based on user feedback, and
wherein the extracted policy rules include policy rules associated with the missed fraud.

17. The computer system of claim 15, wherein the developed policy model is a pre-trained fraud detection model based on a fraud detection policy, and wherein the developing the policy model includes updating at least one of model features and model feature thresholds based on the extracted policy rules.

18. The computer system of claim 15, wherein the classified fraudulent activity types include known fraud, potential fraud, and missed fraud.

19. The computer system of claim 16, wherein the extracted features corresponding to the missed fraud include at least one of remote access software, risky internet service provider (ISP), and risky country.

20. The computer system of claim 15, further comprising:
mapping corresponding extracted features to legitimate activity, potential fraud, known fraud, and missed fraud.
